(19) United States
(12) Patent Application Publication
(10) Pub. No.: US 2013/0048236 A1
(43) Pub. Date: Feb. 28, 2013

(54) METHOD OF MANUFACTURING SHOWER CURTAIN

(71) Applicants: Stephen Blair Brooks, Clemmons, NC (US); Maurice Stafford Parker, Kinston, NC (US)

(72) Inventors: Stephen Blair Brooks, Clemmons, NC (US); Maurice Stafford Parker, Kinston, NC (US)

(73) Assignee: GLENOIT LLC, Goldsboro, NC (US)

(21) Appl. No.: 13/222,893

(22) Filed: Aug. 31, 2011

(51) Int. Cl. B41F 33/00; A47K 3/38

(52) U.S. Cl. 160/330; 101/483

(57) ABSTRACT

Methods and apparatuses are provided for manufacturing a shower curtain. A method may include providing a digital image file representative of an image, printing the image represented by the digital image file onto a film with an ink, illuminating the film with ultraviolet light, and forming one or more openings along a top portion of the film. The method allows for the custom image represented by the digital image file to be printed onto the film without additional downtime for the cleaning or changing of screens that is typically required with traditional roller screen printing processes. Accordingly, a first shower curtain may be printed with a first image, and subsequently a second shower curtain may be printed with a second different image with minimal wait or prep time. Printer systems and devices and related methods of the present invention are also provided.

### TECHNOLOGICAL FIELD

The present invention relates to shower curtains, and more specifically to a method of manufacturing a shower curtain using a digital printer.

### BACKGROUND

Traditionally, shower curtains with patterns, designs, and other graphics have been manufactured using a roller screen printing process. This process, while suitable for mass production of shower curtains, limits a manufacturer's ability to readily print new patterns or designs on shower curtains. Specifically, the roller screen process requires color and design separation by implementing different screens for each color and design during the production of a single shower curtain. Furthermore, the traditional roller screen printing process requires a significant amount of downtime for cleaning and changing screens when a new batch of shower curtains with different patterns or designs is produced. In addition, consumer demand for customizable products is growing.

Therefore, it would be beneficial to provide a method of manufacturing a shower curtain that is economical, efficient, and customizable while maintain the durability and usefulness of the shower curtain.

### BRIEF SUMMARY

One or more embodiments of a method of manufacturing a shower curtain and a shower curtain assembly are disclosed herein that address one or more of the above issues. According to embodiments of the present invention, a method of manufacturing a shower curtain is provided. The method may comprise providing a digital image file representative of an image, printing the image represented by the digital image file onto a material with an ink, illuminating the material with ultraviolet light, and forming a plurality of openings along a top portion of the material. Further, in another embodiment, the method may comprise raster printing.

In another embodiment, the method may include providing a digital image file having a resolution approximately 300 dots per square inch, and wherein printing the image comprises printing at a resolution of approximately 576 and 1200 pixels. According to another embodiment, the ink is configured to polymerize upon being exposed to ultraviolet light.

In one embodiment, the method may comprise printing the image onto a material comprising ethylene vinyl acetate and low density polyethylene. In another embodiment, the material may comprise approximately one-third of the material by weight is low density polyethylene and approximately two-thirds of the material by weight is ethylene vinyl acetate. According to another embodiment, the method may include illuminating the material with approximately between 800 and 1050 watts of ultraviolet light. In another embodiment still, the method may comprise illuminating the material with two 1020 watt ultraviolet bulbs that are energized at less than sixty percent of their total output. According to one embodiment, the method may comprise illuminating the material with two 1020 watt ultraviolet bulbs, wherein a first bulb is energized at approximately forty percent of its total output and a second bulb is energized at approximately fifty percent of its total output.

According to one embodiment, the method may further comprise attaching a header tape to the top portion of the material. Another embodiment may include attaching at least one weight along a bottom portion of the material. Further, the weight may be magnetic. In another embodiment, the method may include affixing a plurality of grommets to the plurality of openings formed along the top portion of the material. The plurality of grommets may comprise a plastic material. In another embodiment, the plurality of grommets may comprise a ceramic material. Alternatively, the plurality of grommets may comprise a metal.

According to another embodiment of the present invention, a shower curtain including a digitally printed image thereon is provided, the shower curtain prepared by a process comprising the steps of providing a digital image file representative of an image, printing the image represented by the digital image file onto a material with an ink, illuminating the material with ultraviolet light, and forming a plurality of openings along a top portion of the material. In one embodiment, a shower curtain may be prepared by a process further including printing the image with an ink configured to polymerize upon being exposed to ultraviolet light. According to another embodiment, the process may include illuminating the material with two 1020 watt ultraviolet bulbs, wherein a first bulb is energized at approximately forty percent of its total output and a second bulb is energized at approximately fifty percent of its total output.

According to one embodiment of the present invention, a shower curtain is provided, the shower curtain comprising a material defining a top portion and a bottom portion, wherein the top portion defines a plurality of openings and the bottom portion comprises a plurality of weights, and a rasterized image printed onto the material by a digital printer using an ink, wherein the material comprises ethylene vinyl acetate and low density polyethylene. In one embodiment, the shower curtain may include an ink that has been polymerized from exposure to ultraviolet light.

These characteristics as well as additional features, functions, and details of the present invention are described below. Similarly, corresponding and additional embodiments of a method of manufacturing a shower curtain and other systems and devices and related products are also described herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a side view of a shower curtain assembly according to one embodiment;

FIG. 2 illustrates a side view of a shower curtain assembly according to another example embodiment;

FIG. 3 illustrates a flowchart of a method for manufacturing a shower curtain according to an example embodiment; and

FIG. 4 is a schematic representation of a system for manufacturing a shower curtain according to an example embodiment.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

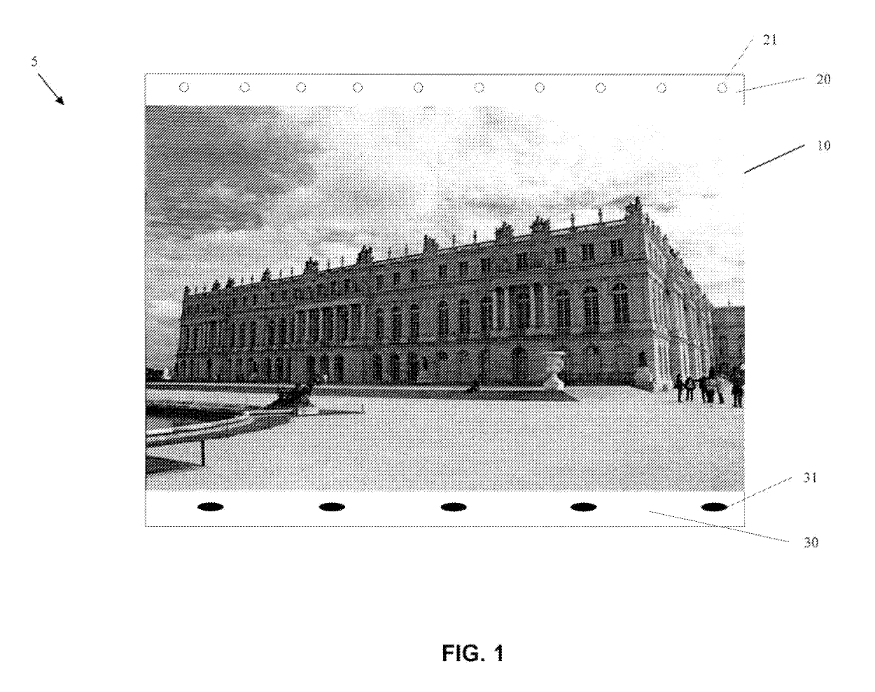

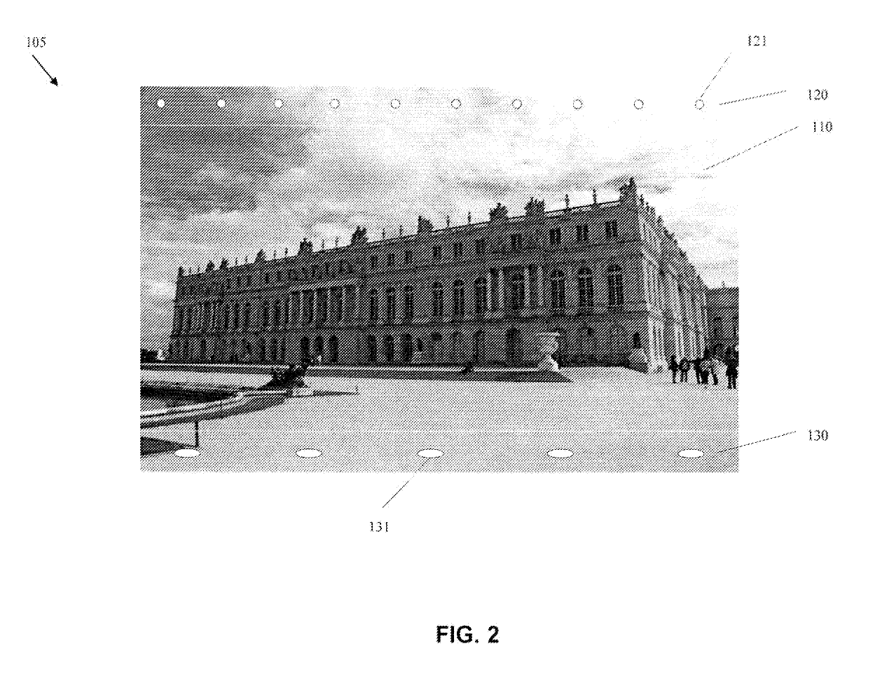

FIG. 1 illustrates a shower curtain 5 manufactured according to one embodiment of the present invention. The shower curtain 5 includes a top portion 20 and a bottom portion 30. Further, the shower curtain 5 may define a plurality of openings 21 disposed along the top portion 20 of the shower curtain 5. The shower curtain 5 may also include a plurality of weights 31 disposed along a bottom portion 30 of the shower curtain 5. The shower curtain 5 may also include an image 10 that is printed between the top portion 20 and the bottom portion 30, but not on the top portion or the bottom portion. In another embodiment, as shown in FIG. 2, the top portion 120 and the bottom portion 130 may include the printed image 110 thereon. In this regard, the printed design 10 may be an image of a landscape, as shown in the embodiments illustrated by FIGS. 1 and 2. In other embodiments, the printed design may include patterns, decorations, shapes, or any of a variety of other designs. As shown in FIG. 1, the shower curtain 5 may be substantially rectangular in shape. Further still, in other embodiments, the shower curtain may be substantially square, circular, oval, or any of a variety of other geometric or non-uniform desired shapes.

An advantageous aspect of embodiments of the shower curtain and method includes allowing a customizable image, pattern, or design to be printed onto the material of the shower curtain. For example, a customer may provide a manufacturer with an individual customized image, pattern, or design to be converted into a digital image file representative of the custom image, pattern, or design. As such, embodiments of the method allow for the custom image represented by the digital image file to be printed onto the material without additional downtime for the cleaning or changing of screens that is typically required with traditional roller screen printing processes. Accordingly, embodiments of the method may provide for manufacturing a first shower curtain with a first image and subsequently and immediately printing a second shower curtain with a second different image.

According to one embodiment, the shower curtain 5 may be manufactured from a material comprising low density polyethylene and ethylene vinyl acetate. Specifically, the material may be a film comprising low density polyethylene and ethylene vinyl acetate. For example, the film may comprise, by weight, approximately between 10% and 50% low density polyethylene and approximately between 90% and 50%, respectively, ethylene vinyl acetate. In some embodiments, the film may comprise, by weight, approximately 50% low density polyethylene and 50% ethylene vinyl acetate. In still other embodiments, the film may comprise approximately one-third low density polyethylene and approximately two-thirds ethylene vinyl acetate, by weight. In other embodiments, the film may comprise polyvinyl chloride, polyethylene, polyester, or any other suitable materials for printing an image on a film using a digital printer. According to other embodiments, the shower curtain 5 may be manufactured from a fabric material. For example, the fabric may comprise woven or non-woven fibers of low density polyethylene, ethylene vinyl acetate, polyester, polyvinyl chloride, polyethylene, or any other suitable fibers for printing an image on a fabric material, which may include such fibers, using a digital printer.

Embodiments of the method of manufacturing shower curtains provide for the ability to use materials, such as those comprising low density polyethylene and ethylene vinyl acetate, that are durable to withstand printing, processing, and other commercial handling, while still maintaining tactile and ocular aesthetics. Another advantage of manufacturing shower curtains according to embodiments of the present invention is the ability to use materials having a surface energy that eliminates the need for treating the material prior to printing, such as with a corona treatment. Specifically, a film used in embodiments of the present invention may have a surface energy such that an ink may be applied to and spread evenly across the film, thus maintaining the image on the film. In contrast, in traditional roller screen printing processes, a film may require a corona treatment to ensure that the ink is applied and dispersed evenly across the film. As such, embodiments of the present invention eliminate the need for treating the film prior to the printing process. Further, materials used for making the film may be selected such that the film has a melting point of approximately 130 degrees Fahrenheit. As such, the film may have a melting point sufficiently high such that exposure to ultraviolet light subsequent to the printing process will not damage the film or detract from its aesthetic appearance. Another advantage manufacturing shower curtains according to embodiments of the present invention includes eliminating the need to use films or materials specifically engineered for use with a digital printer. Such materials may not be readily available and may be expensive to purchase. Accordingly, embodiments of the present invention may provide a method for manufacturing shower curtains using a widely available material and a digital printer.

Additionally, the shower curtain 5 may be manufactured with a film that is approximately between 5 to 8 mils in thickness. In one example embodiment, the film of the shower curtain may be approximately 72 inches wide and 72 inches tall. Further, the shower curtain 5 may include a top portion 20 that may be defined as an area extending downward approximately 1 inch from the top edge of the film. The shower curtain 5 may also include a bottom portion 30 that may be defined as an area extending upwards approximately 1 inch from the bottom edge of the film. In the example embodiment illustrated in FIG. 1, the printed image 10 may extend between the top portion 20 and the bottom portion 30 of the shower curtain 5. In another embodiment, as shown in FIG. 2, the printed image 110 may overlap the top portion 120 and bottom portion 130 so as to extend from the top edge to the bottom edge of the shower curtain 105.

As shown in FIG. 1, the shower curtain 5 may include one or more openings 21 formed in the top portion 20. According to some embodiments, the openings 21 may be substantially circular in shape and may be linearly disposed along the top portion 20 of the shower curtain 5 parallel to the top edge. In other embodiments, the plurality of openings may be substantially oval, rectangular, or any of a variety of other geometric or non-uniform desired shapes. In addition, the shower curtain 5 may include a plurality of weights 31 disposed along the bottom portion 30 of the shower curtain 5. The weights 31 may be embedded within the film or may be coupled to the film along the bottom portion 30, such as via an adhesive or bonding agent. The weights may secure the shower curtain in a desired position during use in a bathtub, shower stall and/or the like (e.g., to keep the shower curtain from moving as a result of airflow past the curtain or the Bernoulli effect). In one embodiment, the plurality of weights may be magnetized such that the bottom portion of the shower curtain remains engaged with a portion of the bathtub during use to keep the curtain in a closed configured (e.g., extended between opposing ends of the bathtub) to minimize the amount of water that escapes the bathtub area.

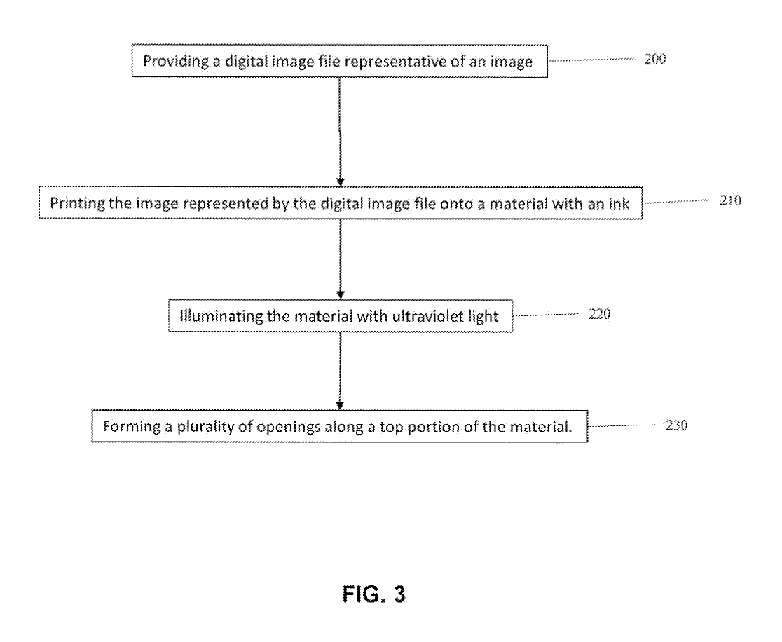

Accordingly, methods of manufacturing a shower curtain as described above are also provided, as shown in FIG. 3. The method of manufacturing the shower curtain may include providing a digital image file representative of an image (Block 200). The method may also comprise printing the image represented by the digital image file onto a material with an ink (Block 210). In addition, the method may include illuminating the material with ultraviolet light (Block 220), and forming a plurality of openings along a top portion of the material (Block 230). The method may further include transmitting a digital image file to a raster image processor of a printer so as to print the desired image, pattern, or design as a rasterized image onto the material. Additionally, the method may also include providing a digital image file with a resolution of approximately 300 dots per square inch. Further, the method may include printing a digital image file onto a material with a printed resolution of approximately 360 by 720 pixels. In another embodiment, the method may include printing a digital image file onto a material with a printed resolution of approximately 576 by 1220 pixels. Another embodiment may include a method comprising printing a digital image file onto a material with a printed resolution of approximately between 300 by 700 pixels and 600 by 1400 pixels. Accordingly, embodiments of the present invention may provide for a digital image file representative of an image to be quickly printed onto a film while still maintaining a proper resolution, allowing for an undistorted and crisp image to be printed on the film.

In another embodiment, the digital image file may be printed onto a material. According to one embodiment, the material may include a film comprising a combination of low density polyethylene and ethylene vinyl acetate. The low density polyethylene and ethylene vinyl acetate may be combined in different proportions to vary the tactile and visual properties of the film, as noted above. For example, the film may comprise less than 50% low density polyethylene and over 50% ethylene vinyl acetate, by weight, such as approximately one-third low density polyethylene and approximately two-thirds ethylene vinyl acetate. According to one embodiment, a film comprising low density polyethylene and ethylene vinyl acetate may provide for a shower curtain having sufficient durability to withstand commercial processing while maintaining a desired tactile feel for aesthetics. Further, the film may be configured to have a melting point of approximately 130 degrees Fahrenheit. As such, the film may be able to withstand exposure to ultraviolet light subsequent to applying ink to the film such that the ink may polymerize without damaging the structure of the film. Other embodiments may include printing an image represented by a digital image file onto a film comprising polyvinyl chloride, polyethylene, polyester, a combination thereof, and/or the like. In some cases, the film may be configured to have a surface energy such that the need for treating the film prior to printing, such as with a corona treatment, is eliminated. In other embodiments still, the material may comprise a fabric comprising a plurality of woven or non-woven fibers, wherein the fibers comprise a polyester material. In another embodiment, the fabric may comprise woven or non-woven fibers comprising low density polyethylene, ethylene vinyl acetate, polyvinyl chloride, polyethylene, a combination thereof, and/or the like.

In one embodiment of the present invention, the method may further comprise printing the image upon a film with an ink, as shown by Block 210 in FIG. 3. The method may include printing the image represented by the digital file onto a film with an ink configured to polymerize upon being exposed to ultraviolet light. Accordingly, embodiments of the present invention provide for an efficient printing process that allows a first image to be printed upon a film, the image defined by the ink applied to the film, and the film with the printed image thereon to be handled and processed without having to wait an additional length of time for the ink to cure.

A suitable printer for manufacturing the shower curtain according to embodiments of the present invention may be configured to print using a number of different colored inks. In one embodiment, the printer may include four colored inks, such as cyan, magenta, yellow, and black. In another embodiment, the printer may include a number of colored inks, such as cyan, magenta, yellow, black, light cyan, and light magenta. Further still, other embodiments may include printing an image upon a film with a printer configured to use, in addition to the colored inks, a white ink. According to one embodiment, the method also includes printing an image upon a film with an ink that includes pigments configured to achieve proper light fastness and/or color fastness, such as pigments configured with a specific coarseness grind. Further, the method may comprise printing an image with an ink configured such that the surface tension of the ink allows for even and uniform spreading when dispersed from a printer inkjet head, such as a piezo-inkjet head. The surface tension of the ink may also allow for applying the ink to the film without a need for pre-treatment of the film, such as with a corona treatment process. One advantage embodiments of the present invention provides include the use of inks which cure substantially faster than inks used in traditional roller screen printing processes.

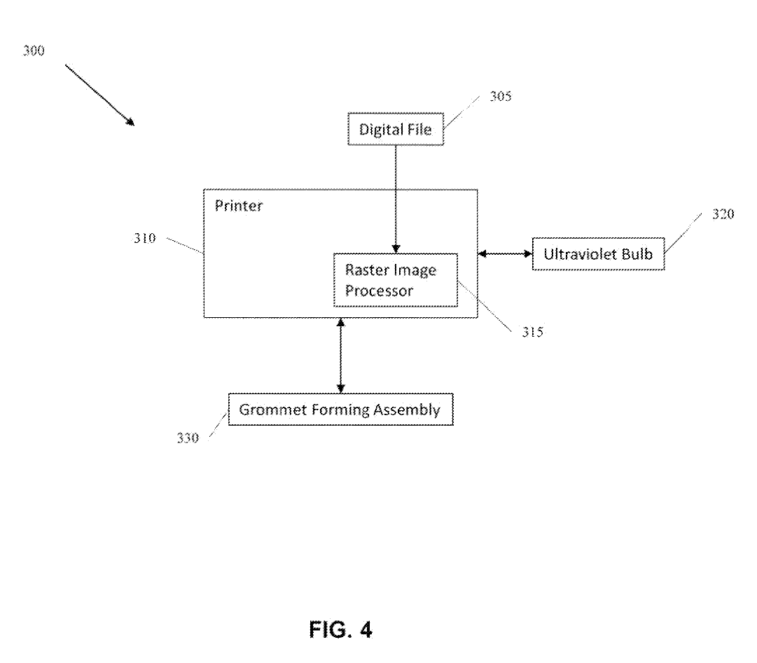

In one embodiment, the method may further include subsequently illuminating the film and ink of a printed rasterized image with an ultraviolet light, as shown by Block 220 in FIG. 3. Further, as shown in FIG. 4, a printer system 300 may include bulbs configured to provide ultraviolet light 320 for illuminating the film subsequent to the printing such that an ink may be properly cured through polymerization. According to one embodiment, the ultraviolet bulbs may be coupled with a printer inkjet head. For example, a first and second ultraviolet bulb may be coupled with the printer inkjet head such that the material is illuminated with the first bulb, the ink is then applied to the material, and the second bulb subsequently illuminates the material after the ink has been applied. The ultraviolet bulb may be configured to illuminate the film and polymerize the ink with approximately between 800 and 1050 watts of ultraviolet light. Alternatively, the system may further include two 1020 watt ultraviolet bulbs for illuminating the film and polymerizing the ink of the printed image. In another embodiment, the printer system may be configured such that the power output of the ultraviolet light may be adjusted, regulated, and/or monitored so as to polymerize the ink without damaging, melting, or otherwise altering the film upon which the ink is applied. In one embodiment of the present invention, two 1020 watt ultraviolet bulbs may be adjusted to output approximately 30% of the total power for properly curing the ink on the film. In another embodiment, the two 1020 watt ultraviolet bulbs may be independently adjusted to modify the respective output of each bulb. For example, a first 1020 watt ultraviolet bulb may be adjusted to output approximately 40% of its total power and a second 1020 watt ultraviolet bulb may be adjusted to output approximately 50% of its total power. In one embodiment, the ink may be configured to polymerize once exposed to ultraviolet light. According to one embodiment, the ink may be configured to substantially polymerize approximately between 1 and 60 seconds once exposed to ultraviolet light. As such, the shower curtain may be handled and processed after the ink has been exposed to ultraviolet light without damaging, altering, or disturbing the image printed onto the material with an ink.

In another embodiment of the present invention, the method may further include finishing a top portion of the film after the ink has been polymerized from exposure to the ultraviolet light. The top portion of the film may be defined as an area extending approximately 1 inch from the top edge of the film and extending along the entire width of the film. The method may further comprise applying a header tape along the top portion of the film, the header tape comprising a film of similar composition to the shower curtain. The header tape may be coupled to the top portion of the film by welds, adhesives, stitching, and/or the like. Further, the header tape may be configured to reinforce the top portion such that the material surrounding the plurality of openings along the top portion of the film is strengthened to prevent the openings from distorting or tearing when the shower curtain is hung from a shower curtain rod by the plurality of openings. Alternatively, in another embodiment, the top portion of the film may be defined by folding a portion of the film onto itself, such as by folding a portion of the film onto itself along a horizontal axis located approximately 1 inch from the top edge of the film.

As shown in FIG. 3, the method may include forming a plurality of openings along the top portion of the film (See Block 230). The openings may be substantially circular in shape. In other embodiments, the openings may be substantially square, rectangular, oval, or any of a variety of other geometric or non-uniform desired shapes. The openings may comprise a plurality of grommets, such as metal, ceramic, plastic grommets and/or the like. As illustrated in FIG. 4, the printer system may further include a grommet forming assembly 330 configured to form openings along the top portion of the film and subsequently attach a grommet to each of the openings. Accordingly, the grommet may provide additional reinforcement to the opening, so as to prevent the material in the area of the openings from tearing during regular and repeated use of the shower curtain.

The method may also include finishing a bottom portion of the film after the ink has been polymerized by exposure to the ultraviolet light. The bottom portion of the film may be defined as an area of the film extending upwards approximately 1 inch from the bottom edge of the film. According to one embodiment, the method may include attaching a one or more weights to the bottom portion of the shower curtain, such that when the shower curtain is used, the one or more weights prevent the shower curtain from being inadvertently displaced, as described above. In another embodiment, the method may include attaching one or more magnetic weights configured to secure the shower curtain to a bathtub, basin, and/or the like when in use.

As shown in FIG. 4, a printer system 300 for manufacturing a shower curtain according to example method embodiments is illustrated. As previously mentioned, a suitable printer 310 according to one embodiment of the present invention may include a raster image processor 315 configured to provide a digital image file representative of a selected image. The printer system 300 may further include or work in conjunction with an ultraviolet bulb 320 for illuminating the ink of the printed image so as to polymerize and cure the ink without damaging or altering the film. The system 300 may also include a grommet forming assembly 330 configured to form a one or more openings along a top portion of the film and to attach one or more grommets to each of the openings. In another embodiment, the printer system may include an anti-static strip assembly configured to remove static electricity from the film prior to printing. Accordingly, such a printer system may provide for the ink to be dispersed and applied more evenly to the film so as to produce a shower curtain with an image printed thereon, the image being substantially free from distortions or other defects produced by an improper application of the ink. Additionally, another embodiment may include a vacuum assembly configured to secure the film to a feed belt of the printer as the image is printed upon the film. In one embodiment, the vacuum assembly may include controls for adjusting the amount of suction power the vacuum assembly provides so as to secure the film to a feed belt of the printer as the image is printed upon the film. For example, in one embodiment, the vacuum assembly may be configured to provide approximately twenty percent of its total suction power for securing the film to a feed belt of the printer. In other embodiments, the vacuum assembly may be configured to provide approximately between ten and thirty percent of its total suction power for securing the film to a feed belt of the printer.

As previously mentioned, another advantage manufacturing shower curtains according to embodiments of the present invention includes eliminating the need to use films or materials specifically engineered for use with a digital printer, wherein such material are extremely expensive and are not readily available. Such specifically-engineered materials, however, provide a suitable medium for printing an image with an acceptable resolution, color fastness, light fastness, wash fastness, and/or the like. As such, embodiments of the present invention may provide for manufacturing a shower curtain using a digital printer with a commercially available film while still providing a shower curtain with an image printed thereon with an acceptable resolution, color fastness, light fastness, wash fastness, and/or the like. Specifically, a printer system for manufacturing a shower curtain according to example method embodiments may include a printer inkjet head configured to be adjustable in height from the film on which the image is being printed. As such, one advantage of embodiments of the present invention may include eliminating the printer inkjet head from contacting the film while the image is being printed onto the film. For example, the vacuum system may be adjusted to prevent the film from buckling, bunching, puckering, cockling, and/or the like, such that the printer inkjet head remains approximately at a designated distance from the film throughout the printing process. In one embodiment, the printer inkjet head may be approximately 0.01 mm from the film. In another embodiment, the printer inkjet head may be approximately 0.02 mm from the film. In another embodiment still, the printer inkjet head may be approximately 0.06 mm from the film.

Further still, a printer system for manufacturing a shower curtain according to example method embodiments may be configured to provide a film for printing a digital image thereon to the inkjet printer head at an appropriate speed such that buckling, bunching, puckering, cockling, and/or the like of the film does not occur. In one embodiment, the printer system may be configured to receive the film at approximately 252 square feet per hour. In another embodiment, the printer system may be configured to receive the film at approximately 432 square feet per hour. The printer system may include digital step let off and take up roll motors configured to be adjustable such that the printer system receives the film for printing an image thereon at a desired speed. Accordingly, the printer system may include a number of assemblies, such as an ultraviolet bulb assembly, a height-adjustable printer inkjet head assembly, a let off and take up roll motor assembly, or a vacuum assembly, for manufacturing a shower curtain according to example method embodiments of the present invention. As such, the printer system may be configured to manufacture a shower curtain in a customizable manner while maintaining efficiency and being economical, and further while maintaining the durability and usefulness of the shower curtain.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of manufacturing a shower curtain, the method comprising:
providing a digital image file representative of an image;
printing the image represented by the digital image file onto a material with an ink;
illuminating the material with ultraviolet light; and
forming a plurality of openings along a top portion of the material.

2. A method according to claim 1, wherein printing the image comprises raster printing.

3. A method according to claim 1, wherein the resolution of the digital image file is approximately 300 dots per square inch, and wherein printing the image comprises printing at a resolution of approximately 576 by 1200 pixels.

4. A method according to claim 1, wherein the ink is configured to polymerize upon being exposed to ultraviolet light.

5. A method according to claim 1, wherein the material comprises ethylene vinyl acetate and low density polyethylene.

6. A method according to claim 5, wherein approximately one-third of the material by weight is low density polyethylene and approximately two-thirds of the material by weight is ethylene vinyl acetate.

7. A method according to claim 1, wherein illuminating the material with ultraviolet light comprises illuminating the material with approximately between 800 and 1050 watts of ultraviolet light.

8. A method according to claim 1, wherein illuminating the material with ultraviolet light comprises illuminating the material with two 1020 watt ultraviolet bulbs that are energized at less than sixty percent of their total output.

9. A method according to claim 8, wherein illuminating the material further comprises illuminating the material with two 1020 watt ultraviolet bulbs, wherein a first bulb is energized at approximately forty percent of its total output and a second bulb is energized at approximately fifty percent of its total output.

10. A method according to claim 1 further comprising attaching a header tape to the top portion of the material.

11. A method according to claim 1 further comprising attaching at least one weight along a bottom portion of the material.

12. A method according to claim 11, wherein at least one of the weights is magnetic.

13. A method according to claim 1 further comprising affixing a plurality of grommets to the plurality of openings formed along the top portion of the material.

14. A method according to claim 13, wherein the plurality of grommets comprise a plastic material.

15. A method according to claim 13, wherein the plurality of grommets comprise a ceramic material.

16. A method according to claim 13, wherein the plurality of grommets comprise metal.

17. A shower curtain including a digitally printed image thereon, the shower curtain prepared by a process comprising the steps of:
providing a digital image file representative of an image;
printing the image represented by the digital image file onto a material with an ink;
illuminating the material with ultraviolet light; and
forming a plurality of openings along a top portion of the material.

18. A shower curtain prepared by the process of claim 17, wherein the process further includes printing the image with an ink configured to polymerize upon being exposed to ultraviolet light.

19. A shower curtain prepared by the process of claim 17, wherein illuminating the material with ultraviolet light comprises illuminating the material with two 1020 watt ultraviolet bulbs, wherein a first bulb is energized at approximately forty percent of its total output and a second bulb is energized at approximately fifty percent of its total output.

20. A shower curtain comprising:
a material defining a top portion and a bottom portion, wherein the top portion defines a plurality of openings and the bottom portion comprises a plurality of weights; and
a rasterized image printed onto the material by a digital printer using an ink,
wherein the material comprises ethylene vinyl acetate and low density polyethylene.

21. A shower curtain according to claim 20, wherein the ink has been polymerized from exposure to ultraviolet light.
